(19) United States
(12) Patent Application Publication
(10) Pub. No.: US 2005/0011332 A1
(43) Pub. Date: Jan. 20, 2005

(54) Method for coloring strings and strings colored thereby

(76) Inventor: Mark Dronge, Tenafly, NJ (US)

Correspondence Address: BRIAN ROFFE, ESQ, 11 SUNRISE PLAZA, SUITE 303, VALLEY STREAM, NY, 11580-6170, US

(21) Appl. No.: 10/620,235

(22) Filed: Jul. 15, 2003

(51) Int. Cl. G10D 3/00

(52) U.S. Cl. 84/297 S

(57) ABSTRACT

Method for manufacturing a set of strings for use with a musical instrument in which a plurality of sizes of the strings in the set are determined and a plurality of colors for the strings in the set is selected, a unique color for each string. For each string, a core wire and a wrap wire, each having a diameter size specific to the size of that string, are provided and only the wrap wire is coated with an enamel having the color of that string. The coated wrap wire is wound around the core wire and the thus-joined wrap wire and core wire are baked to form the string. As a result, each string has its unique color and specific size and when arranged on the instrument, a musician can associate colored notes on a sheet of music with each string and thereby learn how to play the instrument.

### FIELD OF THE INVENTION

The present invention relates generally to methods for forming colored strings for use in musical instruments and a set of strings obtained by the methods. More particularly, the present invention relates to methods for creating a set of colored strings for use in musical instruments which have a specific color for each different size string and a set of colored strings obtained by the methods.

The present invention also relates to a method and arrangement for learning how to play musical string instruments.

### BACKGROUND OF THE INVENTION

String instruments, such as guitars, violins, violas, basses and cellos, generally have a plurality of different sizes of strings which when plucked, vibrate and cause the production of different sounds. Thus, strings for such instruments are often sold as a set, e.g., of four to six strings, with each string having a different size.

In each set, the strings usually have a common color, for example, all of the strings may be black. In view of the common color of the strings, the musician is unable to differentiate between the strings when playing the instrument.

The inability to differentiate between the different strings of the instrument is particularly problematic for people learning to play the instrument, i.e., people unfamiliar with or unaccustomed to the relative location of the individual strings.

It would thus be beneficial to provide a set of strings which enable people learning to play musical string instruments to be able to readily identify the particular strings.

### OBJECTS AND SUMMARY OF THE INVENTION

Accordingly, it is an object of the present invention to provide a new method for forming colored strings for use in musical instruments and a set of strings obtained by the methods.

It is another object of the present invention to provide a new method for creating a set of colored strings for use in musical instruments which have a specific color for each different size string and a set of colored strings obtained by the methods.

It is yet another object of the present invention to provide a set of strings for use on a musical instrument which enable people learning to play the musical instrument to be able to easily and readily identify different strings.

It is still another object of the present invention to provide a method for teaching how to play musical string instruments.

In order to achieve the above objects and others, a method for manufacturing a set of strings for use with a musical instrument in accordance the invention comprises determining a plurality of sizes of the strings in the set, selecting a plurality of colors for the strings in the set, a unique color for each string and for each string, drawing a core wire and a wrap wire each having a diameter size specific to the size of that string, coating only the wrap wire with an enamel having the color of that string, winding the coated wrap wire around the core wire, baking the joined wrap wire and core wire to form the string, and allowing the string thus formed to cure. As a result, each string has its unique color and specific size.

Additional refinements to the basic method include of cleaning the drawn core wire and wrap wire prior to coating of the wrap wire and preparing the colored enamel by mixing a dye of the color of that string with polyester/polyurethane enamel. The dye may be mixed with the polyester/polyurethane enamel in a proportion or 9 parts polyester/polyurethane enamel to 1 part dye.

Coating of the wrap wire may be performed by passing the wrap wire through a bath of the colored enamel. The joined wrap wire and core wire may be baked in an oven whose temperature is selected based on the color of the wrap wire and the material of the wrap wire and core wire.

A set of strings for a musical string instrument in accordance with the invention comprises at least four strings, each having a color different than the color of the other strings in the set and a size different than the size of the other strings in the set. The strings are adapted to be mounted on the instrument to enable playing of the instrument by association of a colored note on a sheet of music to the colors of the strings. Each string may comprise an uncolored core wire and a wrap wire wrapped around the core wire and colored to provide the color of the string. If more than one wrap wire is provided, the outermost wrap wire has the color of the string.

An arrangement for learning to play a musical string instrument in accordance with the invention includes the strings and a sheet of music with colored notes.

### BRIEF DESCRIPTION OF THE DRAWINGS

The following drawings are illustrative of embodiments of the invention and are not meant to limit the scope of the invention as encompassed by the claims.

FIG. 1 is a view of a set of strings in accordance with the invention and manufactured by a method in accordance with the invention.

FIG. 2 is a cross-sectional view of a first embodiment of a string in accordance with the invention.

FIG. 3 is a cross-sectional view of a second embodiment of a string in accordance with the invention.

FIG. 4 is a table of possible combinations of diameter size of a core wire and wrap wire to form bronze acoustic strings.

FIG. 5 is a table of possible combinations of diameter size of a core wire and wrap wire to form nickel strings for electric guitars.

FIG. 6 is a table of possible combinations of diameter size of a core wire and multiple wrap wires to form bass strings.

FIG. 7 is a schematic of an exemplifying method for producing colored strings in accordance with the invention.

### DETAILED DESCRIPTION OF THE INVENTION

Referring to the accompanying drawings wherein like reference numerals refer to the same or similar elements, FIG. 1 shows a set of strings in accordance with the invention designated 10. The set of strings 10 includes six different colored strings with each string having a different size, i.e., diameter. The set of strings 10 is designed for use with a single musical string instrument, i.e., all six strings are installed on that musical instrument. In this manner, a person can learn to play the instrument by associating different notes with the different colored strings.

A primary advantage of providing colored strings on a musical string instrument is that a sheet of music can be provided with the notes in the different colors, i.e., the same colors are the strings, so that a person learning to play the instrument with the colored strings can read the music sheet and pluck the correct string by simply associating the color of the note to the color of the string.

As shown in FIG. 1, an exemplifying set of strings includes a first string 12 having a diameter of about 0.012 inches and colored purple, a second string 14 having a diameter of about 0.016 inches and colored blue, a third string 16 having a diameter of about 0.024 inches and colored green, a fourth string 18 having a diameter of about 0.032 inches and colored yellow, a fifth string 20 having a diameter of about 0.042 inches and colored orange and a sixth string 22 having a diameter of about 0.052 inches and colored red. In one particular embodiment, this set of strings 10 is made of phosphor bronze.

Another exemplifying set of strings includes a first string having a diameter of about 0.009 inches and colored pink, a second string having a diameter of about 0.011 inches and colored yellow, a third string having a diameter of about 0.016 inches and colored blue, a fourth string having a diameter of about 0.024 inches and colored black, a fifth string having a diameter of about 0.032 inches and colored green and a sixth string having a diameter of about 0.042 inches and colored red. In one particular embodiment, this set of strings is made of electric strings with nickel-plated steel windings.

Yet another exemplifying set of strings includes six strings with the order of colors of the strings from smallest diameter string to largest diameter string being orange, blue, yellow, purple, green and red. The particular sizes selected for each set and the color of each string is not critical to the invention provided each string has a different color than the other colors in the set. Possible colors include blue, green, purple, yellow, orange, pink, black, magenta, chrome blue, gold, red and any shade thereof.

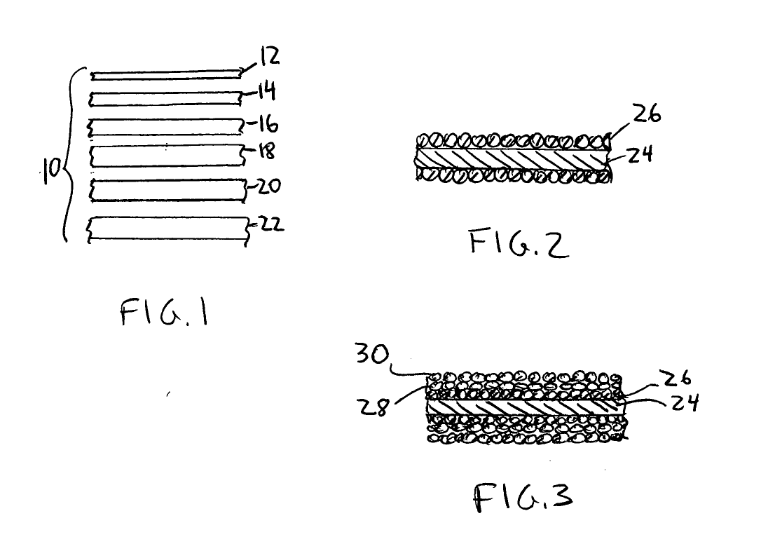

As shown in FIG. 2, each string 12-22 in the set of strings 10 is made of a core wire 24 and a wrap wire 26. The core wire 24 is usually made of carbon steel and the wrap wire 26 may be made of various metals and metal alloys. The wrap wire 26 is the part of the string which provides the string with its color as the core wire is not colored.

The diameter of the core wire and the wrap wire are varied to enable the formation of a set of strings 10 with different sizes, i.e., diameters. In the manufacturing process, the wrap wire 26 is wrapped around the core wire 24 and so encloses the core wire 24 with one portion of the wrap wire 26 above each axial segment of the core wire 24 and one portion of the wrap wire 26 below each axial segment. As such, the diameter of the string 12-22 is approximately equal to the diameter of the core wire 24 plus twice the diameter of the wrap wire 26 (less a fraction resulting from compression of the core and wrap wires 24,26 during the forced wrapping of the wrap wire 26 around the core wire 24).

For example, in the first string having a diameter of about 0.022 inches, the core wire 24 has a (pre-processed) diameter of about 0.012 inches and the wrap wire 26 has a (pre-processed) diameter of about 0.0055 inches. The diameter of the string, without any compression would thus be about 0.023 inches but in view of the compression is actually only about 0.022 inches. In a similar manner, strings having a diameter from 0.024 inches to 0.056 inches can be obtained. Both the diameter of the core wire 24 and the diameter of the wrap wire 26 can be varied so that for each string having a specific diameter, there are numerous ways to fabricate it. The particular manner depends in part on the materials used.

Specifically, to manufacture bronze acoustic strings, the diameter of the core wire 24 may vary from 0.012 inches to 0.019 inches whereas the diameter of the wrap wire 26 varies from 0.0055 inches to 0.019 inches. To manufacture nickel strings for electric guitars, the diameter of the core wire 24 may again vary from 0.012 inches to 0.019 inches whereas the diameter of the wrap wire 26 varies from 0.006 inches to 0.019 inches.

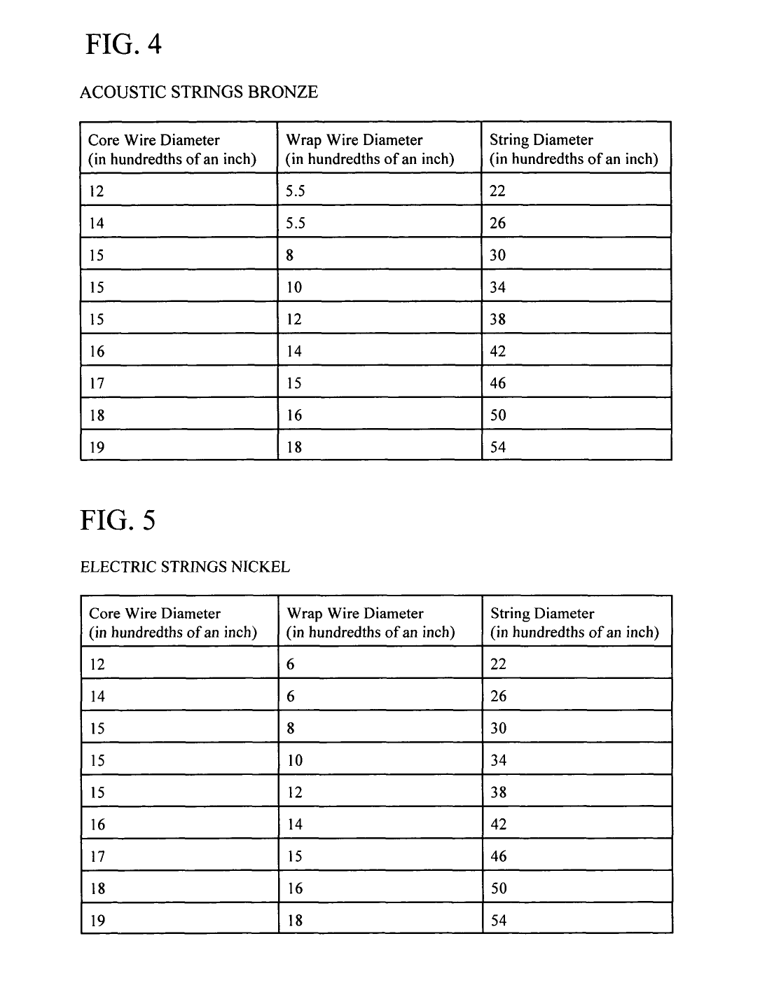

FIGS. 4 and 5 show several possible combinations of the diameter of the core wire 24 and the diameter of the wrap wire 26 to provide strings having various diameters. FIG. 4 is for bronze acoustic strings whereas FIG. 5 is for nickel strings for electric guitars.

For bass strings, it is possible to wrap a plurality of wires around a core wire. As shown in FIG. 3, the core wire 24 is wrapped by a first wrap wire 26 which in turn is wrapped by a second wrap wire 28 which is turn is wrapped by a third wrap wire 30. The second and third wrap wires 28,30 are optional and used for larger diameter bass strings.

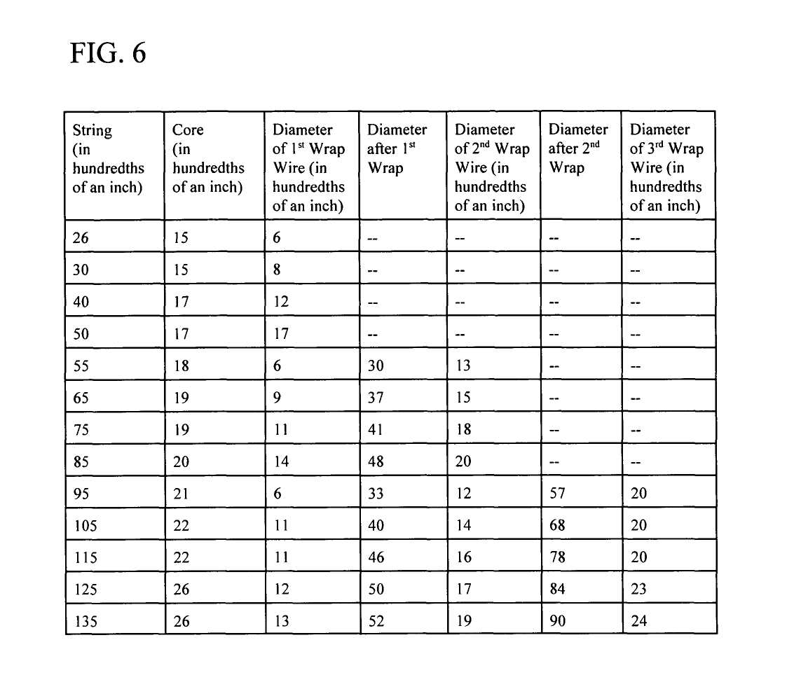

For example, as shown in the table in FIG. 6, bass strings may have a diameter from about 0.026 inches to about 0.135 inches. For those having a diameter from 0.026 inches to about 0.050 inches, only a single wrap wire 26 is used. The diameter of the core wire 24 may vary from about 0.015 inches to about 0.017 inches whereas the diameter of the wrap wire 26 varies from about 0.006 inches to about 0.017 inches. For bass strings having a diameter from about 0.055 inches to about 0.085 inches, two wrap wires 26,28 are used. The diameter of the core wire 24 may vary from about 0.018 inches to about 0.020 inches whereas the diameter of the wrap wire 26 varies from about 0.006 inches to about 0.014 inches and the diameter of the wrap wire 28 varies from about 0.013 inches to about 0.020 inches. For bass strings having a diameter from about 0.090 inches to about 0.135 inches, three wrap wires 26,28,30 are used. The diameter of the core wire 24 may vary from about 0.020 inches to about 0.026 inches whereas the diameter of the wrap wire 26 varies from about 0.006 inches to about 0.013 inches, the diameter of the wrap wire 28 varies from about 0.010 inches to about 0.019 inches and the diameter of the wrap wire 30 varies from about 0.020 inches to about 0.024 inches.

The different diameters of the core 24 and wrap wires 26, 28 and 30 are not critical to the invention.

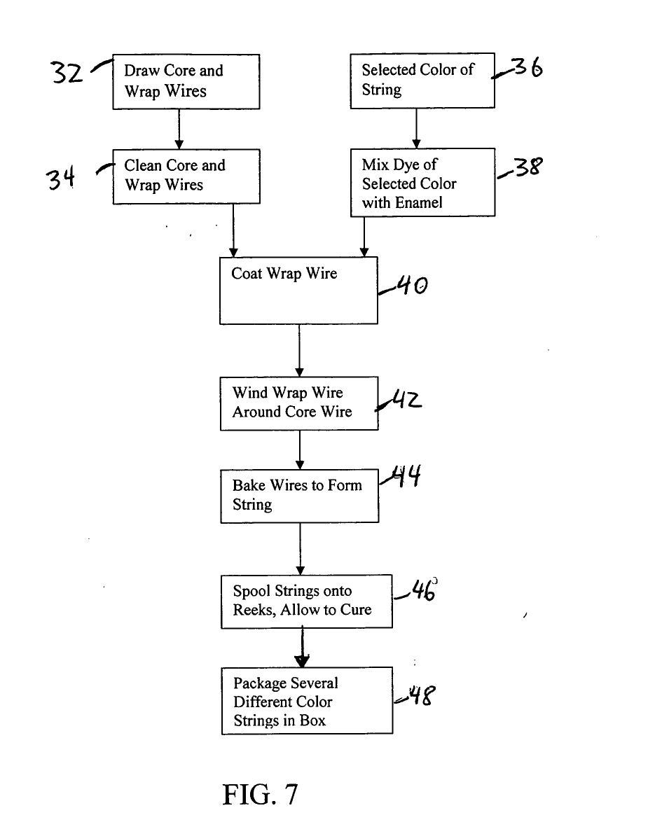

Referring now to FIG. 7, the method in which the strings are manufactured will be explained. The first step in the manufacturing process of each colored string is to draw the core wire and the wrap wire to the proper diameter size (step 32). This may entail drawing a larger diameter wire through dies such as diamond dies. The drawn wires are then preferably cleaned to remove impurities which would adversely affect the sound-generating quality of the finished string, for example, hydrocleaned in a bath of mineral spirits and solvents (step 34). Ultrasonic cleaning may also be used as well as any other known type of cleaning used in the wire art.

Either before, simultaneous with or after the drawing and cleaning of the core and wrap wires, the colored enamel is prepared. Preparation of the colored enamel entails selecting the desired color of the string (step 36) and mixing a dye of the selected color with polyester/polyurethane enamel (step 38). The proportion of dye to enamel may vary depending on the color selected and the properties of the enamel used. In one embodiment when the enamel is 100% nylon, it has been found that a ratio of enamel to dye may be anywhere from 7 parts enamel to one part dye to 11 parts enamel to one part dye, with a preferred mixture being 9 parts enamel to one part dye.

The wrap wire is then coated with a very fine layer of the colored enamel (step 40). The actual coating procedure may involve passing the wrap wire through a bath of the colored enamel or spraying the colored enamel onto the wrap wire during movement of the wrap wire. Other methods for coating the wrap wire known to those in the wire art are also envisioned. It is important to recognize that the core wire is not coated, i.e., only the wrap wire is coated since the wrap wire will completely overlie the core wire and the core wire will not be significantly visible once the wrap wire is wound around it.

Once the wrap wire is coated, it is wound tightly around the core wire (step 42). The next step is to bake the joined wires to bond the enamel to the wrap wires and thereby form colored strings (step 44). Although any type of oven may be used to bake the wires, it has been found that a computer-controlled, horizontal magnet wire oven is particularly useful.

The temperature of the oven, i.e., the temperature at which the joined wires are baked, varies depending on several factors. The temperature range may be from about 500° F. to about 800° F. One factor in particular is the color of the wrap wire since the reflectivity of the color affects the baking. That is, a color having a higher reflectivity would require a higher baking temperature while a color having a lower reflectivity would require a lower baking temperature. For uncolored wires, i.e., wires in which the wrap wires are clear-coated or chrome coated, the baking temperature is, for example, from about 600° F. to about 700° F.

Another factor which influences the baking temperature is the material of the core wire and the wrap wire. The core wire and wrap wire may be made of various alloys such as nickel, nickel-plated steel, tin-plated nickel and phosphor bronze. Thus, the baking temperature depends on the materials of the core wire and wrap wire and the color of the wrap wire. There are numerous different combinations of different materials and different colors and each combination may have an optimum baking temperature. One skilled in the art would readily be able to ascertain, without undue experimentation, an optimum baking temperature, or a range of suitable baking temperatures, for each combination based on the knowledge of the characteristics of the materials used and the selected color.

After baking the joined wires a sufficient time and at a temperature to ensure drying of the enamel on the wrap wires, the strings thus formed are removed from the oven and spooled onto reels of any desired quantity and allowed to cure (step 46). Preferably, the strings should be allowed to cure for about 24 hours. The strings are then sent to winders for processing, i.e., to form strings of the desired length.

Once strings of different colors having different sizes are formed, a set of strings is packaged together in a common box for sale to musicians (step 48).

After installed on the string instrument, a musician is able to learn to play the string instrument using the set of strings 10 in accordance with the invention in conjunction with a special sheet of music printed to include the notes in the different colors of the strings. The sheet of music would include notes having the exact colors as the strings 12-22 so that the musician could associate the note to the string using color.

The invention provides a significant benefit to people learning to play string instruments in that previously, the strings were all the same color and it was difficult to differentiate the strings based on appearance. Although the strings have different diameters, the variation in diameters involved is quite small and not readily discernible. The invention thus provides a different approach to facilitating learning to play a string instrument by introducing a color aspect which readily enables the musicians to finger the string associated with the color of the note on the sheet of music.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A method for manufacturing a set of strings for use with a musical instrument, comprising the steps of:
determining a plurality of sizes of the strings in the set;
selecting a plurality of colors for the strings in the set, a different color for each string; and
for each string,
drawing a core wire and a wrap wire each having a diameter size specific to the size of that string,
coating only the wrap wire with an enamel having the color of that string,
winding the color-coated wrap wire around the core wire,
baking the joined wrap wire and core wire to form the string, and
allowing the string thus formed to cure;
whereby each string has its unique color and specific size.

2. The method of claim 1, further comprising the step of cleaning the drawn core wire and wrap wire prior to coating of the wrap wire.

3. The method of claim 1, further comprising the step of preparing the colored enamel by mixing a dye of the color of that string with polyester/polyurethane enamel.

4. The method of claim 3, wherein the dye is mixed with the polyester/polyurethane enamel is a proportion or 9 parts polyester/polyurethane enamel to 1 part dye.

5. The method of claim 1, wherein the step of coating only the wrap wire comprises the step of passing the wrap wire through a bath of the colored enamel.

6. The method of claim 1, wherein the step of baking the joined wrap wire and core wire comprises the steps of baking the joined wrap wire and core wire in an oven and selecting the temperature of the oven based on the color of the wrap wire and the material of the wrap wire and core wire.

7. (Canceled)

8. A set of strings for a musical string instrument, comprising:
at least four strings, each of said strings having a color different than the color of the other of said strings in said set and a size different than the size of the other of said strings in said set,
said strings being adapted to be mounted on the instrument to enable playing of the instrument by association of a colored note on a sheet of music to the colors of said strings.

9. The set of strings of claim 8, wherein each of said strings comprises an uncolored core wire and a wrap wire wrapped around said core wire, said wrap wire being colored to provide the color of said string.

10. The set of strings of claim 8, wherein each of said strings comprises an uncolored core wire, a first wrap wire wrapped around said core wire and a second wrap wire wrapped around said first wrap wire, said second wrap wire being colored to provide the color of said string.

11. The set of strings of claim 8, wherein each of said strings comprises an uncolored core wire, a first wrap wire wrapped around said core wire, a second wrap wire wrapped around said first wrap wire and a third wrap wire wrapped around said second wrap wire, said third wrap wire being colored to provide the color of said string.

12. The set of strings of claim 8, wherein said at least four strings comprises six strings.

13. An arrangement for learning to play a musical string instrument, comprising:
a sheet of music to be played by the instrument having notes, each of the notes being colored a color different than the color of the other notes; and
a set of at least four strings, each of said strings in said set having a color different than the color of the other of said strings in said set and a size different than the size of the other of said strings in said set, the colors of said strings being the same as the colors of the notes,
whereby said strings are adapted to be mounted on the instrument to enable playing of the instrument by association of a colored note on said sheet of music to the colors of said strings.

14. The arrangement of claim 13, wherein each of said strings comprises an uncolored core wire and a wrap wire wrapped around said core wire, said wrap wire being colored to provide the color of said string.

15. The arrangement of claim 13, wherein each of said strings comprises an uncolored core wire, a first wrap wire wrapped around said core wire and a second wrap wire wrapped around said first wrap wire, said second wrap wire being colored to provide the color of said string.

16. The arrangement of claim 13, wherein each of said strings comprises an uncolored core wire, a first wrap wire wrapped around said core wire, a second wrap wire wrapped around said first wrap wire and a third wrap wire wrapped around said second wrap wire, said third wrap wire being colored to provide the color of said string.

17. The arrangement of claim 13, wherein said set of strings comprises six strings.
